(19) United States
(12) Patent Application Publication
(10) Pub. No.: US 2015/0010741 A1
(43) Pub. Date: Jan. 8, 2015

(54) Heat Activated Shrink Films

(71) Applicant: Avery Dennison Corporation, Glendale, CA (US)

(72) Inventors: Hoang T. PHAM, Painesville, OH (US); Anle XUE, Mentor, OH (US); Yatin PATIL, Mayfield Heights, OH (US)

(21) Appl. No.: 14/322,725

(22) Filed: Jul. 2, 2014

Related U.S. Application Data
(60) Provisional application No. 61/842,305, filed on Jul. 2, 2013.

(51) Int. Cl. B32B 27/08; B32B 7/02; C08L 23/06; B32B 27/32; C08L 57/00

(52) U.S. Cl. CPC B32B 27/08; B32B 27/325; C08L 57/00; C08L 23/06; B32B 7/02; B32B 2250/40; B32B 2307/736; B32B 2323/00; C08L 2207/066
USPC 428/213; 428/515; 428/500; 525/55; 525/240

(57) ABSTRACT

Shrinkable film layers having a blend of (i) one or more polymers with a high glass transition temperature, and (ii) one or more polymers with a low glass transition temperature are disclosed. Methods for preparing such film layers are also disclosed.

### BACKGROUND OF THE INVENTION

Shrink films have numerous uses, including as product labels and for packaging. The present invention further provides embodiments of shrink films and also methods for preparing shrink films.

### SUMMARY OF THE INVENTION

In one embodiment, the invention includes a shrink film with at least a first shrinkable film layer. The shrinkable film layer includes a blend of a shrinkable polymer having a high glass transition temperature, and a shrinkable polymer having a low glass transition temperature.

In another embodiment, the present invention includes a method for preparing a shrinkable film. The method includes preparing a blend comprising a shrinkable polymer having a high glass transition temperature and a shrinkable polymer having a low glass transition temperature, and forming a film from the blend.

The following description illustrates one or more embodiments of the invention and serves to explain the principles and exemplary embodiment of the invention.

### BRIEF DESCRIPTION OF THE DRAWINGS

FIG. 1 is a graph of oven shrink values of exemplary films; and

FIG. 2 is a graph of DMA shrink curves of exemplary films.

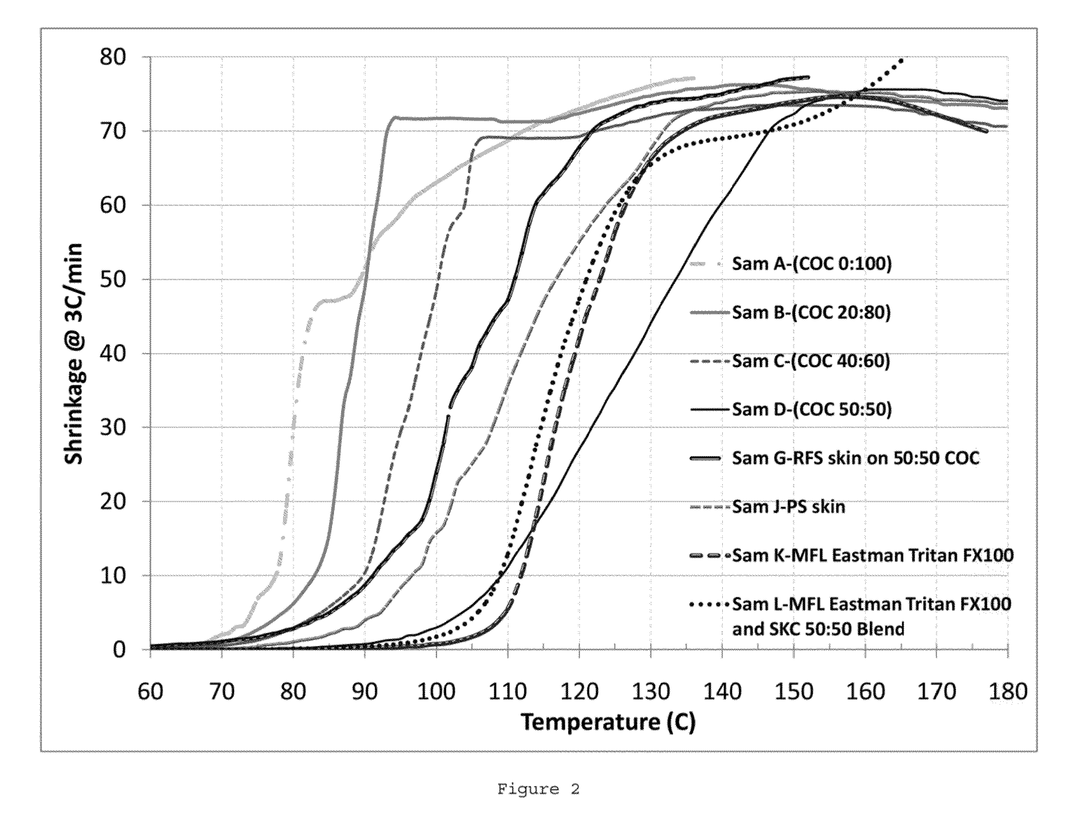

### DETAILED DESCRIPTION OF EXEMPLARY EMBODIMENTS

Reference will now be made in detail to exemplary embodiments of the present invention, one or more examples of which are illustrated in the accompanying drawings. Each example is provided by way of explanation of the invention and not by limitation of the invention. It will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

As is understood in the art, shrink films are films that shrink in at least one direction when heated to a shrink initiation temperature. In some embodiments, shrink films of the present invention may shrink only in the machine direction upon exposure to a shrink initiation temperature. In other embodiments, shrink films may alternatively or additionally shrink in the transverse direction (also called the cross direction) upon exposure to a shrink initiation temperature. In still other embodiments, shrink films of the present invention may shrink only in the machine direction upon exposure to a shrink initiation temperature and may also grow (or expand) in the cross direction.

In some embodiments, the present invention includes films comprised of at least one shrinkable layer prepared using a blend of (i) at least one shrinkable polymer having a high glass transition temperature (Tg), and (ii) at least one shrinkable polymer having a low Tg. In some specific embodiments, films of the present invention may have at least one film layer prepared using (i) at least one cyclic olefin copolymer (COC) having a high glass transition temperature, and (ii) at least one COC having a low glass transition temperature. As used herein, high Tg indicates a glass transition in the range of about 85° C. to about 165° C. and low Tg indicates a glass transition temperature lower than about 85° C. The foregoing ranges shall include each intermittent value and each intermittent range therein.

Any combination of one or more shrinkable polymers having a high Tg and one or more shrinkable polymers having a low Tg are within the scope of the present invention. In some particular embodiments, polymers having high Tg may include polymers having a Tg in the range of about 85° C. to about 160° C. In other embodiments, polymers having a Tg of about 90° C. to about 155° C. may be used as a high Tg polymer. In addition, in some particular embodiments, polymers having a Tg from about −100° C. to about 85° C. may be used as a low Tg polymer. In some embodiments, polymers having a Tg from about −60° C. to about 85° C. may be used as a low Tg polymer. In yet other embodiments, polymers having a Tg in the range of about −40° C. to 83° C. may be used as a low Tg polymer. In still other embodiments, polymers having a Tg in the range of about −35° C. to about 82° C. may be used as a low Tg polymer. In yet other embodiments, polymers having a Tg of less than about 80° C. may be used as a low Tg polymer. Each of the foregoing ranges shall include each intermittent value and each intermittent range therein.

Any suitable blend of high and low Tg polymers may be used in particular embodiments of the present invention. In some embodiments, a shrinkable layer may include about 1% to about 99% by weight of shrinkable polymers having a high glass transition temperature and about 1% to about 99% by weight shrinkable polymers having a low glass transition temperature, including each intermittent range therein for each. In some embodiments, a shrinkable layer may include about 10% to about 80% by weight of shrinkable polymers having a high glass transition temperature and about 20% to about 90% by weight shrinkable polymers having a low glass transition temperature

By way of example, in some embodiments, one or more high Tg COC polymers and one or more low Tg COC polymers may be blended in a shrinkable layer. In other embodiments, a high Tg COC may be blended with a low Tg polyolefin to form a shrinkable layer. In still other embodiments, polystyrene, which has a high Tg, may be blended with a styrene block copolymer having a low Tg, such as styrene ethylene butylene styrene polymers (SEBS), styrene ethylene/propylene styrene (SEPS) polymers, styrene butadiene (SBR), styrene-ethylene/propylene-styrene (SEPS), and poly(styrene-butadiene-styrene) polymers (SBS), to form a shrinkable layer. Additionally, in some embodiments, a shrinkable layer may include a high Tg polyethylene terephthalate glycol-modified (PETG) and/or polycarbonate blended with a low Tg PETG and/or low Tg polyethylene terephthalate (PET). The foregoing embodiments are intended to be illustrative of specific embodiments of the present invention without limiting its full scope.

In addition, although embodiments herein are discussed in the context of glass transition temperatures, the present invention also includes embodiments wherein the shrinkable layer polymer blend is alternatively based upon heat deflection temperatures (also called the heat distortion temperatures) (HDT). In this regard, such shrinkable layers may comprise a blend of (i) at least one polymer, such as a COC, having a high heat deflection temperature, and (ii) at least one polymer, such as a COC, having a low heat deflection temperature. As used herein, a high heat deflection temperature includes temperatures above about 75° C., and low heat deflection temperature includes temperatures at about or below about 75° C.

Shrinkable layers of the present invention having a blend of a high Tg polymer and a low Tg polymer may optionally include other components. By way of example, in some embodiments, the shrinkable layer may include one or more additional polymer materials, such as linear low density polyethylene or low density polyethylene. In addition, such layers may also contain other components such as pigments, fillers, stabilizers, light protective agents or other suitable modifying agents if desired. These film layers may also contain anti-block, slip additives and anti-static agents. Useful anti-block agents include inorganic particles, such as clays, talc, calcium carbonate and glass. Slip additives useful in the present invention include polysiloxanes, waxes, fatty amides, fatty acids, metal soaps and particulate such as silica, synthetic amorphous silica and polytetrafluoroethylene powder. Anti-static agents useful in the present invention include alkali metal sulfonates, polyether-modified polydiorganosiloxanes, polyalkylphenylsiloxanes and tertiary amines.

In some embodiments, shrinkable layers of the present invention may include from about 5% to about 50% by weight of a semi-crystalline polymer. By way of example, such semi-crystalline polymers may include olefinic polymers, such as linear low density polyethylene, low density polyethylene, and other polyethylenes. In some embodiments having a shrinkable layer with a blend of high and low Tg COC polymers, the shrinkable layer may include one or more semi-crystalline polymers having a density in the range of about 0.90 g/cc to about 0.94 g/cc. In other embodiments, shrinkable layers having a blend of high and low Tg COC polymers may include semi-crystalline polymers having a density in the range of about 0.905 g/cc to about 0.935 g/cc. In still other embodiments, shrinkable layers having a blend of high and low Tg COC polymers may include semi-crystalline polymers having a density in the range of about 0.91 g/cc to about 0.93 g/cc.

Films of the present invention may be single layer films having a blend of high and low Tg polymers or, in other embodiments, may be multilayer films wherein at least one layer is prepared using a blend of high and low Tg polymers. In some embodiments, shrinkable layers having at least one high Tg polymer and one low Tg polymer may constitute at least about 5% of the total thickness of a multilayer film. In some embodiments, shrinkable layers having a blend of at least one high Tg polymer and one low Tg polymer may constitute about 2% to about 30% of the total thickness of a multilayer film. In other embodiments, such high Tg and low Tg blend shrinkable layers may constitute about 5% to about 25% of the total thickness of a multilayer film. In addition, in some embodiments, such as in Samples F-H discussed below, a multilayer film may have a first shrink layer that includes a high and low Tg blend and at least a second shrink layer that does not include a high and low Tg blend.

In some multilayer film embodiments of the present invention, other layers may include, by way of example, skin layers, tie layers, core layers, print layers, and adhesive layers. In some embodiments, a core may include a polymeric material, such as a polyolefin resin or blends thereof. For example, the core layer in some embodiments of the present invention may be comprised of low density polyethylene, linear low density polyethylene, medium density polyethylene, ethyl vinyl acetate, polypropylene, and blends thereof. In some embodiments, the core layer may additionally or alternatively be comprised of elastomers and/or plastomers. In some embodiments, the core layer may also be prepared with other non-olefinic material, such as styrene ethylene butylene styrene (SEBS), poly(styrene-butadiene-styrene) (SBS), poly(styrene-isoprene-styrene) (SIS), and other similar components.

The following samples provide certain exemplary embodiments in accordance with some aspects of the present invention. As shown below for Samples A-E are films having a shrinkable layer with a high Tg COC (indicated as TOPAS 5013) and a low Tg COC (indicated as TOPAS 8007), and the weight ratio of high Tg COC to low Tg COC is varied for each sample. In addition, Samples F-H show exemplary compositions for embodiments of a film skin layer wherein a tie layer includes a blend of high Tg COC and low Tg COC. In similar fashion, the weight ratio of high Tg polymer to low Tg polymer in the tie layer is varied between these samples. Samples I-J use a high Tg polystyrene (indicated as Polystyrene EA3400 and having a Tg of about 102° C.) and low Tg styrene ethylene butylene styrene polymers (SEBS) (indicated as Kraton G2832 and having a Tg of −42° C.). Finally, Sample K employs a high Tg PETG (indicated as FX100, which is available from Eastman as Tritan Copolyester FX100 and has a Tg of 110° C.) and Sample L employs FX100 and a low Tg PETG (indicated as SKC, which is available from SK Chemicals as Skygreen K2012 and has a Tg of 82° C.). As reflected in the data below, the layer percentage is a volumetric percentage reflecting the thickness ratio of the layer.

TABLE I

| | | Sample A | Sample B | Sample C | Sample D | Sample E |
|---|---|---|---|---|---|---|
| Layers | | 3 Layers [A-C-A] | 3 Layers [A-C-A] | 3 Layers [A-C-A] | 3 Layers [A-C-A] | 3 Layers [A-C-A] |
| Skin Layer | layer % | 20-35% | 20-35% | 20-35% | 20-35% | 20-35% |
| (A) | Composition | Topas COC 8007: | Topas COC 8007: | Topas COC 8007: | Topas COC 8007: | Topas COC 8007: |
| | | Topas COC 5013: | Topas COC 5013: | Topas COC 5013: | Topas COC 5013: | Topas COC 5013: |
| | | Dowlex LDPE 722 | Dowlex LDPE 722 | Dowlex LDPE 722 | Dowlex LDPE 722 | Dowlex LDPE 722 |
| | | (85:0:15) | (68:17:15) | (51:34:15) | (42.5:42.5:15) | (34:51:15) |
| | COC Ratio | 8007:5013 (100:0) | 8007:5013 (80:20) | 8007:5013 (60:40) | 8007:5013 (50:50) | 8007:5013 (40:60) |
| Core Layer | layer % | 65-80% | 65-80% | 65-80% | 65-80% | 65-80% |
| (C) | Composition | Versify 2300 (100) | Versify 2300 (100) | Versify 2300 (100) | Versify 2300 (100) | Versify 2300 (100) |
| | | Sample F | Sample G | Sample H | Sample I | Sample J |
| Layers | | 5 Layers [A-B-C-B-A] | 5 Layers [A-B-C-B-A] | 5 Layers [A-B-C-B-A] | 5 Layers [A-B-C-B-A] | 5 Layers [A-B-C-B-A] |
| Skin Layer | layer % | 5-20% | 5-20% | 5-20% | 20-35% | 20-35% |
| (A) | Composition | Topas COC 8007: | Topas COC 8007: | Topas COC 8007: | American Styrenics | American Styrenics |
| | | Dow Elite 6111: | Dow Elite 6111: | Dow Elite 6111: | Polystyrene EA3400: | Polystyrene EA3400: |
| | | Ampacet Antiblock | Ampacet Antiblock | Ampacet Antiblock | Kraton G2832 (93:7) | Kraton G2832 (93:7) |
| | | (84:15:1) | (84:15:1) | (84:15:1) | | |
| | COC Ratio | NA | NA | NA | NA | NA |
| Tie Layer | layer % | 10-25% | 10-25% | 10-25% | 10-20% | 10-20% |
| (B) | Composition | Topas COC 8007: | Topas COC 8007: | Topas COC 8007: | Septon 2004 | Dowlex LDPE 722: |
| | | Topas COC 5013: | Topas COC 5013: | Topas COC 5013: | | Amplify 3351 |
| | | Dow Elite 6111 | Dow Elite 6111 | Dow Elite 6111 | | (10:90) |
| | | (51:34:15) | (42.5:42.5:15) | (34:51:15) | | |
| | Blend Ratio | 8007:5013 (60:40) | 8007:5013 (50:50) | 8007:5013 (40:60) | NA | NA |
| Core Layer | layer % | 45-85% | 45-85% | 45-85% | 55-70% | 55-70% |
| (C) | Composition | Versify 2300 (100) | Versify 2300 (100) | Versify 2300 (100) | Huntsman LDPE | Huntsman LDPE |
| | | | | | PE1017: | PE1017: |
| | | | | | Dowlex LDPE 722: | Dowlex LDPE 722: |
| | | | | | Engage 8842 | Engage 8842 |
| | | | | | (40:50:10) | (40:50:10) |

| | | Sample K | Sample L |
|---|---|---|---|
| Layers | | 3 Layers [A-C-A] | 3 Layers [A-C-A] |
| Skin Layer (A) | layer % | 20-35% | 20-35% |
| | Composition | FX 100 (99%) | FX 100 (49.5%) |
| | | Eastman Antiblock | SKC (49.5%): |
| | | in PETG (1%) | Eastman Antiblock |
| | | | in PETG (1%) |
| | PETG Ratio | FX 100 (100:0) | FX 100:SKC (50:50) |
| Core Layer (C) | layer % | 65-80% | 65-80% |
| | Composition | FX-100 (100%) | FX-100 (50%) |
| | | | SK PETG (50%) |

As used in certain examples in Table I, the low Tg polymer was Topas COC 8007 (which has a HDT/B of 75° C.) and the high Tg polymer was Topas COC 5013 (which has a HDT/B of 130° C.), wherein both are available from Topas Advanced Polymers, Inc. In addition, low density polyethylene products used are referenced as Dowlex LDPE (which has a density of 0.918 g/cm³) and Dow Elite 6111 (which has a density of 0.912 g/cm³ and is an enhanced polyethylene resin with an ethylene-octene copolymer), both of which are available from the Dow Chemical Company. Furthermore, Versify 2300 is an elastomer having a density of 0.867 g/cm³ and also is available from The Dow Chemical Company. The antiblock referenced is available under the brand name Crystal Clear 102077 Antiblock Additive PE MB, which is available from Ampacet Corporation. With regard to Sample K and L, as noted above, the high Tg material was PETG (indicated as FX100, which is available from Eastman as Tritan Copolyester FX100 and has a Tg of 110° C.) and, for Sample L employs FX100 and a low Tg PETG (indicated as SKC, which is available from SK Chemicals as Skygreen K2012 and has a Tg of 82° C.).

In other examples in Table I, polystyrene was the high Tg polymer, and EA3400 indicates a polystyrene product available from American Styrenics, LLC, and SEBS was the low Tg polymer, wherein G2832 indicates a Kraton G2832 is a styrene-ethylene/butylenes-styrene (SEBS) block copolymer available from Kraton Polymers. In addition, LDPE indicates low density polyethylene, specifically Dowlex LDPE 722 available from The Dow Chemical Company, Septon 2004 indicates a styrene ethylene propylene styrene block copolymer available under the brand name Septon 2004 from Kuraray CO., Ltd., Amplify 3351 indicates a maleic anhydride grafted polymer available under the brand name Amplify 3351 from The Dow Chemical Company, Huntsman LDPE PE1017 indicates low density polyethylene under the brand name PE1017 available from Huntsman Corporation, Dowlex LDPE 722 indicates a low density polyethylene available under the brand name Dowlex LDPE 722 from The Dow Chemical Company, and Engage 8842 indicates a polyolefin elastomer available from the Dow Chemical Company. One of ordinary skill in the art readily appreciates that the foregoing specific references to compounds in Table I are exemplary in nature only and that other components with suitable properties may be used in addition to or instead of these components.

Samples A-L were also tested for MD oven shrinkage, DMA shrink curve and for various optical properties. The MD oven shrinkage was tested by punching 4″ by 4″ film portions for the samples. For each sample, a different portion was placed in an oven that was one of the temperatures listed in the data below. The portion was heated for five minutes and then measured to determine the dimensional change (shrinkage or growth) in each direction. The reported values below are the percentage shrink in the machine direction from the original portion. The DMA shrink testing was conducted for each sample by placing a strip of the sample in a rheometer and applying a small load to strip in the tension direction to avoid curling. Heat was then applied at a rate of 3° C./min. The strip was be monitored and the data below, which provides the change in dimension as a function of temperature, were recorded. The optical properties were tested using the following procedures. For gloss, specular gloss of plastic films was measured at 60° pursuant to Standard ASTM D2457. Transmittance, haze, and clarity were determined by measuring the resultant light passed through the plastic film from a light source pursuant to Standard ASTM D2457.

Although the samples above indicate layer percentage ranges, the actual testing was conducted on films have the following layer percentages:

### Samples A-E

Skin layer 25% total (12.5% on each side)

Core layer 75% total

### Samples F-H

Skin layer 10% total (5% on each side)

Tie layer 20% total (10% each side)

Core layer 70% total

### Samples I-J

Skin layer 25% total (12.5% on each side)

Tie layer 14% total (7% each side)

Core layer 61% total

### Samples K-L

Skin layer 25% total (12.5% on each side)

Core layer 75% total

| | Sample | Sample | Sample | Sample | Sample | Sample | Sample | Sample | Sample | Sample | Sample | Sample |
|---|---|---|---|---|---|---|---|---|---|---|---|---|
| | A | B | C | D | E | F | G | H | I | J | K | L |
| MD Oven | | | | | | | | | | | | |
| Shrinkage | | | | | | | | | | | | |
| @ 5 min | | | | | | | | | | | | |
| 70° C. | 14 | 11 | 7 | 0 | 0 | | | | 1 | 1 | 0 | 0 |
| 80° C. | 58 | 49 | 16 | 1 | 1 | | | | 3 | 3 | 0.5 | 0.5 |
| 90° C. | 63 | 62 | 52 | 3 | 2 | 33 | 15 | 11 | 10 | 9 | 1 | 2.8 |
| 100° C. | 69 | 67 | 58 | 14 | 9 | 60 | 30 | 44 | 42 | 36 | 6.8 | 17.8 |
| 110° C. | 74 | 71 | 70 | 27 | 24 | | | | 68 | 55 | 48 | 50 |
| 125° C. | 81 | 78 | 74 | 60 | 53 | 73 | 68 | 69 | 74 | 75 | — | — |
| 140° C. | 86 | 83 | 79 | | 74 | | | | | | 54 | 57 |
| DMA Shrink | | | | | | | | | | | | |
| curve @ 3 C./min | | | | | | | | | | | | |
| Shrink Onset | 69° C. | 73° C. | 77° C. | 97° C. | Not tested | 75° C. | 73° C. | 75° C. | | 84° C. | 78° C. | 74° C. |
| temperature | | | | | | | | | | | | |
| Temp @ 2% | | | | | | | | | | | | |
| Shrink | | | | | | | | | | | | |
| Temp @ 5% | 74° C. | 78° C. | 83° C. | 103° C. | Not tested | 81° C. | 81° C. | 84° C. | | 92° C. | 110° C. | 105° C. |
| Shrink | | | | | | | | | | | | |
| Temp @ 35% | 80° C. | 87° C. | 96° C. | 124° C. | Not tested | 89° C. | 100° C. | 99° C. | | 109° C. | 118° C. | 116° C. |
| Shrink | | | | | | | | | | | | |
| Optical | | | | | | | | | | | | |
| Properties | | | | | | | | | | | | |
| Transmittance | 92.5 | 92.5 | 92.5 | 92.1 | 92.6 | 91.7 | 91.7 | 91.5 | 90.5 | 90.2 | Not Tested | Not Tested |
| Haze (%) | 4.4 | 6.6 | 7.7 | 12.0 | 17.4 | 4.7 | 4.9 | 8.6 | 2.5 | 3.9 | Not Tested | Not Tested |
| Clarity (%) | 98 | 97 | 95 | 95 | 95 | 96 | 97 | 94 | 99 | 95 | Not Tested | Not Tested |
| MD Gloss @ 60 | 101 | 91 | 86 | 78 | 64 | 103 | 97 | 85 | 130 | 115 | Not Tested | Not Tested |
| Degrees (GU) | | | | | | | | | | | | |
| CD Gloss @ 60 | 92 | 87 | 78 | 67 | 53 | 84 | 90 | 76 | 124 | 113 | Not Tested | Not Tested |
| Degrees (GU) | | | | | | | | | | | | |

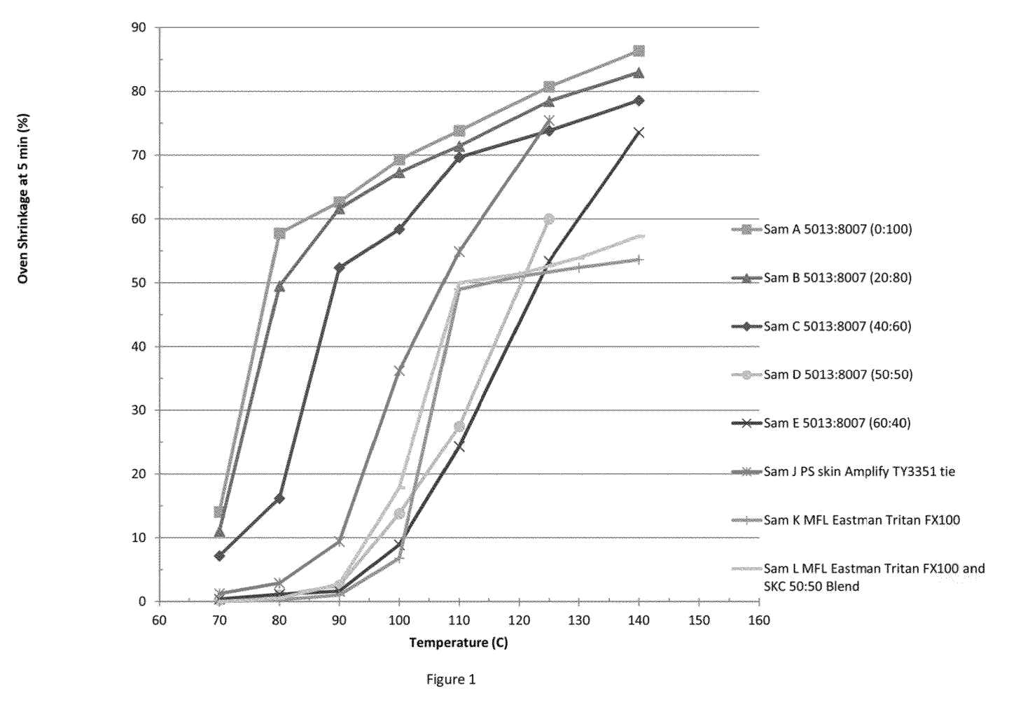

As indicated in the results above, the shrinkage properties of a film may be varied based upon the ratio of high Tg polymer to low Tg polymer. Furthermore, as shown in FIG. 1, the initiation shrink temperature is a non-linear function of high Tg polymer to low Tg polymer. As such, this shrink initiation temperature may be adjusted in particular embodiments by varying the ratio of high Tg polymer to low Tg polymer in the shrinkable layer. In general, as shown in the figures, it was generally observed that an increase in the high Tg component yielded an increase in the shrink initiation temperature. In addition, as shown by the comparison of Sample K and Sample L, the blended skin layer in Sample L of high Tg PETG and low Tg PETG (in this case, a low Tg of about 82° C.) resulted in shifting the activation temperature of the film as compared with the high Tg PETG layer of Sample K.

Appreciating this correlation, in some embodiments of the present invention, the shrink initiation temperature may be controlled for a film by the ratio of high Tg polymer to low Tg polymer in the shrinkable film layer. For example, through the blending of such components in a film layer, the shrink initiation temperature may be adjusted to a desirable level. As a result, using extrapolations from testing various film layers having different ratios of high Tg polymers to low Tg polymers, the data may be extrapolated to determine the necessary ratio to achieve a certain shrink initiation temperature for a film. Such embodiments of the present invention allow a film to be prepared with a suitable shrink initiation temperature, which may avoid the film undesirably shrinking at normal storage or transportation temperatures.

These and other modifications and variations to the present invention may be practiced by those of ordinary skill in the art without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

What is claimed is:

1. A shrink film with at least a first shrinkable film layer comprising a blend of:
a shrinkable polymer having a high glass transition temperature, and
a shrinkable polymer having a low glass transition temperature.

2. The shrink film of claim 1 wherein the shrinkable polymer having a high glass transition temperature is a cyclic polyolefin copolymer.

3. The shrink film of claim 1 wherein the shrinkable polymer having a low glass transition temperature is a cyclic polyolefin copolymer.

4. The shrink film of claim 1 wherein the high glass transition temperature polymer has a glass transition temperature in the range of about 85° C. to about 165° C.

5. The shrink film of claim wherein the high glass transition temperature polymer has a glass transition temperature in the range of about 90° C. to about 155° C.

6. The shrink film of claim 1 wherein the low glass transition temperature polymer has a glass transition temperature of less than about 85° C.

7. The shrink film of claim 4 wherein the low glass transition temperature polymer has a glass transition temperature in the range of about −100° C. to 83° C.

8. The shrink film of claim 1 the high glass transition temperature polymer has a glass transition temperature in the range of about 90° C. to about 155° C. and the low glass transition temperature polymer has a glass transition temperature in the range of about −60° C. to about 84° C.

9. The shrink film of claim 7 wherein the shrink film is a single layer film.

10. The shrink film of claim 7 wherein the shrink film is a multilayer layer film.

11. The shrink film of claim 1 wherein the shrink film is a multilayer film and a second shrinkable film layer comprises a shrinkable polymer having a high glass transition temperature and a shrinkable polymer having a low glass transition temperature.

12. The shrink film of claim 1 wherein the first shrinkable film layer further comprises an additional polymer.

13. The shrink film of claim 1 wherein the first shrinkable film further comprises one or more additional polymers selected from the group consisting of low density polyethylene, linear low density polyethylene, and combinations thereof.

14. The shrink film of claim 1 wherein the first shrinkable film layer comprises an elastomer.

15. The shrink film of claim 1 wherein the weight ratio shrinkable polymer having a high glass transition temperature and a shrinkable polymer having a low glass transition temperature in the first shrinkable film layer is in the range of about 60:40 to about 1:99.

16. The shrink film of claim 1 further comprising a core layer.

17. The shrink film of claim 16 wherein the core layer is comprised of a polyolefin.

18. The shrink film of claim 16 wherein the core layer is comprised of a material selected from the group consisting of low density polyethylene, linear low density polyethylene, medium density polyethylene, ethyl vinyl acetate, polypropylene, elastomers, plastomers, styrene ethylene butylene styrene, poly(styrene-butadiene-styrene), poly(styrene-isoprene-styrene) (SIS), terephthalate glycol-modified (PETG), polyethylene terephthalate (PET), and blends thereof.

19. The shrink film of claim 10 wherein layers comprising a blend of at least one high Tg polymer and one low Tg polymer constitute at least about 5% of the total thickness of a multilayer film.

20. The shrink film of claim 10 wherein layers of the film comprising a blend of at least one high Tg polymer and one low Tg polymer constitute from about 2% to about 30% of the total thickness of the film.

21. The shrink film of claim wherein the film is configured such that a shrink initiation temperature of the film is substantially controlled by a weight ratio of the shrinkable polymer high glass transition temperature and the shrinkable polymer having a low glass transition temperature controls.

22. A method for preparing a shrinkable film, wherein the method comprises:
preparing a blend comprising a shrinkable polymer having a high glass transition temperature and a shrinkable polymer having a low glass transition temperature, and
forming a film from the blend.

23. The method of claim 22 wherein the weight ratio of the shrinkable polymer having a high glass transition temperature and the shrinkable polymer having a low glass transition is selected to achieve a desired shrink initiation temperature of the film.
